(19) United States
(12) Patent Application Publication
(10) Pub. No.: US 2025/0357042 A1
(43) Pub. Date: Nov. 20, 2025

(54) SINGLE-PHASE TRANSFORMER FOR VEHICLE ELECTRICAL ENERGY STORAGE UNIT CHARGER

(71) Applicant: Valeo eAutomotive Germany GmbH, Erlangen (DE)

(72) Inventors: Farshid SARRAFIN ARDEBILI, Cergy Pontoise (FR); Hasan MOUSAVI SOMARIN, Cergy Pontoise (FR); Norbert MESSI, Cergy Pontoise (FR); Luiz BRAZ, Cergy Pontoise (FR)

(73) Assignee: Valeo eAutomotive Germany GmbH, Erlangen (DE)

(21) Appl. No.: 19/206,724

(22) Filed: May 13, 2025

(30) Foreign Application Priority Data
May 16, 2024 (FR) FR2405048

(51) Int. Cl. H01F 30/10; B60L 53/14; H01F 27/26; H01F 27/34; H02M 1/00

(52) U.S. Cl. CPC H01F 30/10; B60L 53/14; H01F 27/26; H01F 27/34; H02M 1/0048; B60L 2210/10

(57) ABSTRACT

Single-phase transformer for a voltage converter includes a magnetic circuit, a primary winding, and a secondary winding. The magnetic circuit includes a central leg around which the secondary winding and successive parts of the primary winding are successively wound. The central leg successively including, along its longitudinal axis, a first portion around which a first part of the primary winding is wound, a second portion around which the secondary winding is wound, and a third portion around which a second part of the primary winding is wound. One or more gaps are provided in the second portion of the central leg.

The present invention relates to a single-phase transformer for a component for supplying electric power to a vehicle electrical energy storage unit, this component also being called a “charger” for this electrical energy storage unit. The electrical energy storage unit is, for example, a battery, which can have a nominal voltage that is greater than 60 V, for example greater than or equal to 300 V, 400 V, 800 V, or even 1000 V. In a known example, this charger comprises:
an inverter/rectifier whose input receives an AC voltage from an electrical network and whose output supplies a DC voltage, and
a DC/DC converter disposed downstream of the inverter/rectifier and connected to the electrical energy storage unit and incorporating an isolation transformer which may be single-phase or polyphase.

There is a need to further improve such chargers. The aim of the invention is to meet this need, and it does so, according to one of its aspects, using a single-phase transformer for a voltage converter, comprising:
a magnetic circuit,
a primary winding, and
a secondary winding,
   the magnetic circuit comprising a central leg around which the secondary winding and successive parts of the primary winding are successively wound, the central leg successively comprising along its longitudinal axis:
a first portion around which a first part of the primary winding is wound,
a second portion around which the secondary winding is wound, and
a third portion around which a second part of the primary winding is wound, one or several gaps being provided in the second portion of the central leg.

This positioning of the gaps at the second portion of the central leg around which the secondary winding is wound makes it possible to modify the reluctance of the magnetic circuit. It is thus possible to better control the magnetic path and to concentrate the leakage inductance on the primary side of the transformer. It is thus possible to improve the magnetic coupling between the primary and the secondary of the transformer and thus to reduce the energy losses. This arrangement of the gaps, due to its action on the leakage inductance, also makes it possible for this leakage inductance to constitute the resonant inductance. It is then no longer necessary to provide a physical component mounted in series with the primary winding of the transformer in order to realize this resonant inductance. This then results in a saving in weight, bulk and cost. This also results in better efficiency due to the fact that the copper and iron losses associated with the presence of the physical component forming the resonant inductance are avoided.

An odd number of gaps may be provided in the second portion of the central leg, notably three or five gaps.

The first part and the second part of the primary winding may be mounted in series.

Each gap may be filled with adhesive, FR4, or be occupied by air.

Each gap may extend over the same dimension along the longitudinal axis of the central leg. In a variant, this dimension may vary from one gap to the other.

The distance along the longitudinal axis of the central leg separating two consecutive gaps may be constant over all of the gaps provided in the second portion of the central leg. The manufacture of the segments of the central leg is thus simplified. In a variant, this distance may vary over all of the gaps.

The median plane of the median gap within the plurality of gaps of the second portion of the central leg may be a plane of symmetry for the central leg.

The central leg may not have gaps elsewhere than in the second portion.

In all of the above, the central leg may have a circular or oval cross section.

In all of the above, the magnetic circuit of the transformer may comprise:
two outer legs between which the central leg is physically disposed, and
two yokes, each yoke being disposed at a longitudinal end and allowing the magnetic flux circulating in the central leg to be looped in the outer legs.
   The flux circulating in the central leg and looping in the outer legs advantageously does not pass across gaps other than those provided in the second portion of the central leg.

Each yoke may be produced in one piece with part of the central leg and of each outer leg. This piece may then have an “E” shape.

The magnetic circuit may form a shell for the transformer, the electrical winding being contained in the magnetic circuit.

Within the meaning of the present application:
“axial” or “axially” means “moving along the longitudinal axis of the central leg”, and
“radial” or “radially” means “in a plane perpendicular to the longitudinal axis of the central leg, along a radius by analogy with the case where the cross section of the central leg is circular”.

In all of the above, the ratio between the number of turns of the secondary winding and the number of turns of the primary winding may lie between 1 and 1.1. Such a transformer ratio value is notably relevant when the electrical energy storage unit has a nominal voltage of 800 V and when the DC/DC voltage converter is of the CLLC type.

In a variant, the ratio between the number of turns of the secondary winding and the number of turns of the primary winding may lie between 0.5 and 0.6. Such a transformer ratio value is notably relevant when the electrical energy storage unit has a nominal voltage of 400 V, so as to adapt the output voltage of an upstream inverter/rectifier to this nominal voltage of 400 V, and when the DC/DC voltage converter is of the CLLC type.

The number of turns may or may not be equal from one part of the primary winding to the other.

In all of the above, each part of the primary winding may be divided into radially stacked layers. The number of layers may be equal between the two parts of the primary winding. Within one part of the primary winding, the turns may succeed one another along the longitudinal axis of the central leg within the same layer, then, at the axial end of the layer, the turns are offset radially, succeeding one another axially in the next layer, radially speaking, up to the other axial end of this next layer, and so on.

The secondary winding may be divided into radially stacked layers. Similarly to what has been outlined above, within the secondary winding, the turns may succeed one another along the longitudinal axis of the central leg within the same layer, then, at the axial end of the layer, the turns are offset radially, succeeding one another axially in the next layer, radially speaking, up to the other axial end of this next layer, and so on.

The number of radially stacked layers of the secondary winding may be equal to the number of radially stacked layers of each part of the primary winding.

In all of the above, each of the primary winding and the secondary winding may be produced using a Litz wire comprising between 1100 and 1400 strands, for example 1400 strands. Each strand has, for example, a diameter of between 50 μm and 100 μm, for example 50 μm or 60 μm or 71 μm.

For the primary, respectively secondary, winding, use is for example made of a single Litz wire with the aforementioned number of strands and the aforementioned strand diameter.

In a variant, only the secondary winding is produced with the Litz wire comprising between 1100 and 1400 strands, each strand having a diameter of between 50 μm and 100 μm. Such an embodiment of the secondary winding with this type of Litz wire is notably suitable for a 800 V/400 V DC/DC voltage converter.

The use of such a Litz wire may make it possible to reduce the alternating current losses and to reduce the proximity effect in the transformer, thus improving the performance of the transformer. These improvements are notably enabled by the increase in the effective copper section in the secondary winding, by virtue of which the current density is increased.

The primary and secondary windings may be mounted on a coil support, itself mounted on the central leg. In a known manner, a resin which is able to be polymerized (potting) in order to harden and immobilize the elements with which it comes into contact may be introduced between the central leg, the coil support and the electrical windings. The shape of the coil support, for example via through-openings provided in free electrical winding zones, may be selected to promote the distribution of the resin, and therefore to improve the cooling of the transformer.

The choice of the material for the central leg, such as MnZn ferrite, and the positioning of the primary and secondary windings along the central leg may make it possible to reduce the fringing effect in the transformer.

The transformer may make it possible to transfer a power of the order of 11 kW.

A further subject of the invention, according to another of its aspects, is a DC/DC voltage converter, comprising a transformer as defined above. This DC/DC voltage converter is for example a resonant converter. This DC/DC voltage converter is for example of the 800 V/800 V or 800 V/400 V type.

A further subject of the invention, according to another of its aspects, is a charger for an electrical energy storage unit of a vehicle, comprising:
an inverter/rectifier able to be electrically connected to an AC voltage network, and
the DC/DC voltage converter as defined above, this DC/DC voltage converter being able to be electrically interposed between the inverter/rectifier and the electrical energy storage unit. The primary winding may then be electrically connected on the side of the inverter/rectifier and the secondary winding may then be connected on the side of the electrical energy storage unit.

The inverter/rectifier may be controlled so as to have at its DC output a voltage of 800 V and the DC/DC voltage converter is then configured to adapt this voltage value as a function of the value of the nominal voltage of the electrical energy storage unit, the latter having for example the value of 400 V or 800 V, as already mentioned. Thus, depending on whether the electrical energy storage unit has a nominal voltage whose value is 400 V or 800 V, the transformer ratio is selected to adapt the voltage of 800 V at the DC output of the inverter/rectifier to this value of 400 V or 800 V.

The inverter/rectifier may perform a power factor correction function. Such a correction makes it possible, in a known manner, for the current drawn from the network to be as close as possible to a perfect sine at the angular frequency of the network. This reduces the reactive current and the subharmonics that increase the conduction energy losses.

The charger is for example reversible, alternately enabling:
the charging of the electrical energy storage unit from the electrical network, and
the supply of electrical power for a load or the electrical network from the electrical energy storage unit.

In all of the above, the voltage of the electrical network may be polyphase, in particular three-phase. This voltage may have a frequency of 50 Hz or 60 Hz and a rms value of 230 V or 240 V. In a variant, the network voltage may be single-phase.

Where appropriate, the charger may comprise a device for detecting an insulation fault between one at least of:
a phase of the AC voltage and ground, and
the neutral of the AC voltage and ground, such a detection device is for example realized according to the teaching of the application WO2024199839 or according to the teaching of the European EP4434795.

In another variant, the network may supply a DC voltage. In this case, the charger does not have an inverter/rectifier upstream of the DC/DC voltage converter.

The charger may, or may not, be contained in a housing also receiving another DC/DC voltage converter making it possible to convert the voltage of the electrical energy storage unit into the voltage of the on-board network, this other DC/DC voltage converter ensuring for example a conversion:
800 V/12 V
800 V/48 V
400 V/12 V, or
400 V/48 V

The invention will be better understood upon reading the following description of non-limiting examples of implementation thereof:

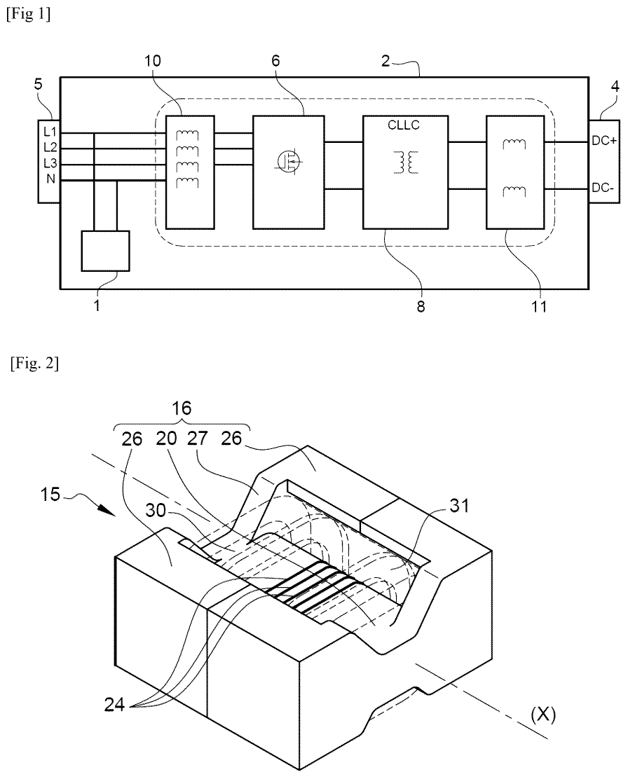

FIG. 1 shows a charger ensuring the supply of electrical power for an electrical energy storage unit of a vehicle,

FIG. 2 shows a schematic view of a transformer according to an example of implementation of the invention forming part of the charger in FIG. 1,

FIG. 3 is a view in axial section of the transformer in FIG. 2, and

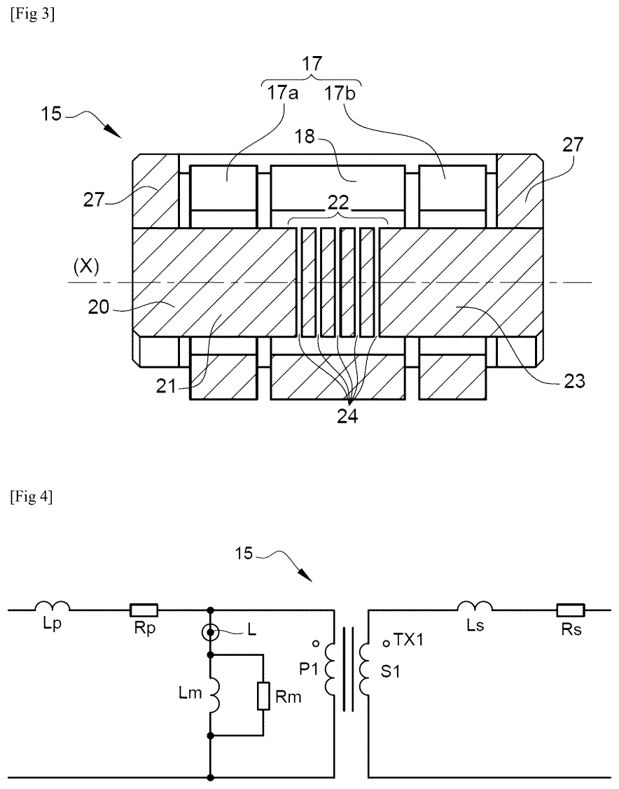

FIG. 4 is an electrical circuit modelling the transformer in FIGS. 2 and 3.

FIG. 1 shows a charger 2 for an electrical energy storage unit 4 of a vehicle. This charger 2 comprises:
a connector 5 able to be connected to an electrical network supplying an AC voltage in the example in question,
an inverter/rectifier 6, and
a DC/DC voltage converter 8.

As can be seen in FIG. 1, the inverter/rectifier 6 is in this case disposed in cascade between the connector 5 and the DC/DC voltage converter 8.

The electrical energy storage unit 4 is in this case a battery used for supplying electrical power to an electrical vehicle propulsion machine. This battery has, for example, a nominal voltage greater than 60 V, in particular greater than 300 V, in particular greater than 400 V, in particular greater than 800 V, or even 1000 V.

The electrical network is, for example, a three-phase network conveying a voltage at a first frequency, which is 50 Hz or 60 Hz and whose rms value is 230 V or 240 V.

As shown in FIG. 1, an AC filtering stage 10 may be provided, this filtering stage 10 being disposed in series between the connector 5 and the inverter/rectifier 6 here. This filtering stage 10 makes it possible, for example, when the AC voltage is polyphase, to filter the common-mode current and/or to filter the differential current.

Where appropriate, optionally, another DC filtering stage 11 may be present, being then disposed in series between the DC/DC voltage converter 8 and the electrical energy storage unit 4, as shown in FIG. 1.

The DC/DC voltage converter 8 is, for example, a resonant converter, for example of the CLLC or CLLLC or LLC type.

The DC/DC voltage converter 8 comprises a single-phase transformer 15 making it possible to establish electrical isolation within the charger 2 and to adapt the voltage gain of the converter.

As can be seen in FIGS. 2 to 4, the transformer 15 comprises:
a magnetic circuit 16,
a primary winding 17, and
a secondary winding 18.

In the example in question, the magnetic circuit 16 comprises a central leg 20 around which the secondary winding 18 and successive parts 17a, 17b of the primary winding 17 are successively wound. The parts 17a and 17b of the primary winding 17 are mounted in series in the example in question.

As can be seen in FIG. 3, the central leg 20 successively comprises along its longitudinal axis (X):
a first portion 21 around which a first part 17a of the primary winding 17 is wound,
a second portion 22 around which the secondary winding 18 is wound, and
a third portion 23 around which a second part 17b of the primary winding 17 is wound.

It is also noted in FIG. 3 that a plurality of gaps 24 are provided in the second portion 22 of the central leg 20. In the example in FIGS. 2 and 3, all the gaps 24 are radially surrounded by the secondary winding 18.

In the example in FIG. 3, five gaps 24 are provided in the second portion 22 of the central leg 20, but the invention is not limited to such a number.

It is also noted in FIG. 3 that all the gaps 24 are identical, each being occupied by air or FR4 and extending over the same dimension along the longitudinal axis (X) of the central leg 20. It is also noted in FIG. 3 that the distance along this longitudinal axis (X) separating two consecutive gaps remains constant over all of the gaps 24 provided in the second portion 22 of the central leg 20. Still in the example in question, the central leg 20 does not have gaps elsewhere than in the second portion 22.

In all of the above, the central leg 20 has, for example, an oval cross section.

As can be seen in FIG. 2, the magnetic circuit 16 of the transformer 15 also comprises in the example in question:
two outer legs 26 between which the central leg 20 is physically disposed, and
two yokes 27, each yoke 27 being disposed at a longitudinal end along the axis (X) and allowing the magnetic flux circulating in the central leg 20 to be looped in the outer legs 26.

As can be seen in FIG. 2, each yoke 27 may have cutouts at the junction with the central leg in order to reduce the section of the magnetic circuit at this junction.

In the example in FIG. 2, each yoke 27 is produced in one piece with part of the central leg 20 and of each outer leg 26, such that the magnetic circuit 16 comprises two “E”-shaped pieces. It is noted in FIG. 2 that the magnetic circuit 16 encapsulates the primary winding 17 and the secondary winding 18, forming a kind of shell for the transformer 15. This shell has, for example, the following dimensions:
length along the longitudinal axis (X): 61 mm,
width in a plane perpendicular to the axis (X): 66 mm,
height in a plane perpendicular to the axis (X): 31.1 mm.

All these dimensions of the magnetic circuit 16 may thus be less than 10 cm.

The magnetic circuit 16 is, for example, produced from ferrite.

As can be seen in FIG. 2, the transformer 15 may comprise a coil support 30, for example made of plastic, which is interposed between the various windings 17, 18 and the central leg 20. This coil support 30 comprises a plurality of ridges 31 which succeed one another along the longitudinal axis (X) and separate in pairwise fashion the parts of the primary winding 17 and the secondary winding 18.

A resin which is able to be polymerized (potting) in order to harden and immobilize the elements with which it comes into contact may occupy all or part of the space present inside the magnetic circuit 16 so as to be interposed between the central leg 20, the coil support 30 and the primary windings 17 and 18.

In the example in question, each part 17a, 17b of the primary winding 17 may be divided into radially stacked layers. The number of layers may be equal between the two parts 17a, 17b of the primary winding. There are, for example, three radially stacked layers of electrical conductor. The turns of each part 17a, 17b of the primary winding may be distributed as follows, identically between the parts 17a, 17b:
within the radially inner layer, the turns succeed one another along the longitudinal axis (X) from one axial end to the other of this layer, then,
at the axial end of this layer, the turns pass to the next layer, radially speaking, and succeed one another axially in this next layer up to the other axial end, and so on.

Similarly to what has just been described, the secondary winding 18 may be divided into radially stacked layers, for example into three radially stacked layers, that is to say the same number of layers as within the parts of the primary winding 17. The turns may also succeed one another along the longitudinal axis (X) within the radially inner layer, then, at the axial end of this layer, the turns may pass to the next layer, radially speaking, up to the other axial end of this next layer, and so on.

In a first application, the DC/DC voltage converter 8 converts a voltage of 800 V at the DC output of the inverter/rectifier 6 into a voltage of 400 V which corresponds to the nominal voltage of the electrical energy storage unit 4. In this application, the ratio between the number of turns of the secondary winding 18 and the number of turns of the primary winding 17 may be between 0.5 and 0.6. The secondary winding 18 has, for example, 13 turns, whereas the first part 17a of the primary winding 17 has 12 turns and the second part 17b of the primary winding has 13 turns. There is thus a transformer ratio of 13/25. The secondary winding 18 is, for example, produced using a 1400-strand Litz wire with a diameter of 50 μm for each strand. The primary winding 17 is in this case produced with the Litz wire, of which the number of turns and the strand diameter is different.

The transformer 15 as dimensioned above for the 800 V/400 V application corresponds for example to the circuit diagram in FIG. 4, with:
a magnetizing inductance Lm equal to 105 μH,
a primary leakage inductance Lp equal to 32 μH,
a secondary leakage inductance Ls equal to 0.3 μH.

In a second application, the DC/DC voltage converter 8 converts a voltage of 800 V at the DC output of the inverter/rectifier 6 into a voltage of 800 V which corresponds to the nominal voltage of the electrical energy storage unit 4. In this application, the ratio between the number of turns of the secondary winding 18 and the number of turns of the primary winding 17 may be between 1 and 1.1. The secondary winding 18 has, for example, 26 turns, whereas the first part 17a of the primary winding 17 has 12 turns and the second part 17b of the primary winding has 13 turns. There is thus a transformer ratio of 26/25. The secondary winding 18 is, for example, produced using a Litz wire, of which the number of strands and the strand diameter may be different from that described with reference to the first application.

The transformer 15 as dimensioned above for the 800 V/800 V application corresponds for example to the circuit diagram in FIG. 4, with:
a magnetizing inductance Lm equal to 105 μH,
a primary leakage inductance Lp equal to 32 μH,
a secondary leakage inductance Ls equal to 0.3 μH.

The invention is not limited to the example that has just been described.

In one variant, the AC voltage of the network is single-phase.

In another variant, the voltage of the electrical network is DC voltage.

1. Single-phase transformer for a voltage converter, comprising:
a magnetic circuit,
a primary winding, and
a secondary winding,
the magnetic circuit comprising a central leg around which the secondary winding and successive parts of the primary winding are successively wound, the central leg successively comprising along its longitudinal axis:
a first portion around which a first part of the primary winding is wound,
a second portion around which the secondary winding is wound, and
a third portion around which a second part of the primary winding is wound,
one or several gaps being provided in the second portion of the central leg.

2. Transformer according to claim 1, an odd number of gaps being provided in the second portion of the central leg, notably three or five gaps.

3. Transformer according to claim 1, each gap extending over the same dimension along the longitudinal axis of the central leg.

4. Transformer according to claim 1, the distance along the longitudinal axis of the central leg separating two consecutive gaps being constant over all of the gaps provided in the second portion of the central leg.

5. Transformer according to claim 1, the central leg not having gaps elsewhere than in the second portion.

6. Transformer according to claim 1, the ratio between the number of turns of the secondary winding and the number of turns of the primary winding lying between 1 and 1.1.

7. Transformer according to claim 1, the ratio between the number of turns of the secondary winding and the number of turns of the primary winding lying between 0.5 and 0.6.

8. Transformer according to claim 1, each part of the primary winding being divided into radially stacked layers, and the number of layers being equal between the two parts of the primary winding.

9. Transformer according to claim 1, the secondary winding being divided into radially stacked layers.

10. Transformer according to claim 8, the number of radially stacked layers of the secondary winding being equal to the number of radially stacked layers of the parts of the primary winding.

11. DC/DC voltage converter, comprising a transformer according to claim 1, the converter notably being resonant.

12. Charger for an electrical energy storage unit of a vehicle, comprising:
an inverter/rectifier able to be electrically connected to an AC voltage network, and
the DC/DC voltage converter according to claim 11, this DC/DC voltage converter being able to be electrically interposed between the inverter/rectifier and the electrical energy storage unit.

13. Transformer according to claim 2, each gap extending over the same dimension along the longitudinal axis of the central leg.

14. Transformer according to claim 2, the distance along the longitudinal axis of the central leg separating two consecutive gaps being constant over all of the gaps provided in the second portion of the central leg.

15. Transformer according to claim 2, the central leg not having gaps elsewhere than in the second portion.

16. Transformer according to claim 2, the ratio between the number of turns of the secondary winding and the number of turns of the primary winding lying between 1 and 1.1.

17. Transformer according to claim 2, the ratio between the number of turns of the secondary winding and the number of turns of the primary winding lying between 0.5 and 0.6.

18. Transformer according to claim 2, each part of the primary winding being divided into radially stacked layers, and the number of layers being equal between the two parts of the primary winding.

19. Transformer according to claim 2, the secondary winding being divided into radially stacked layers.

20. Transformer according to claim 9, the number of radially stacked layers of the secondary winding being equal to the number of radially stacked layers of the parts of the primary winding.
